(19) United States
(12) Patent Application Publication
(10) Pub. No.: US 2020/0107675 A1
(43) Pub. Date: Apr. 9, 2020

(54) BAKING SUBSTRATE

(71) Applicant: COFRESCO FRISCHHALTEPRODUKTE GMBH & CO. KG, Minden (DE)

(72) Inventor: Hans-Jürgen ARNING, Lübbecke (DE)

(73) Assignee: COFRESCO FRISCHHALTEPRODUKTE GMBH & CO. KG, Minden (DE)

(21) Appl. No.: 16/499,859

(22) PCT Filed: Mar. 29, 2018
(86) PCT No.: PCT/EP2018/058045

§ 371 Date: Sep. 30, 2019

(30) Foreign Application Priority Data
Apr. 4, 2017 (DE) 20 2017 101 994.2

(51) Int. Cl. A47J 37/01; A47J 36/02; A21B 3/15; D21H 27/02; D21H 19/84; D21H 19/32

(52) U.S. Cl. CPC A47J 37/01; A47J 36/025; A21B 3/15; H01F 1/047; D21H 19/84; D21H 19/32; D21H 27/02

(57) ABSTRACT

A baking substrate made of a sheet-type material has, on an upper side, an embossed structure provided with an anti-adhesive coating. An underside is made to be flat at least in some sections, and at least the flat sections have a non-slip coating in at least some parts.

### CROSS-REFERENCE TO RELATED APPLICATIONS

This application is a U.S. National Stage Application of International Patent Application No. PCT/EP2018/058045, filed Mar. 29, 2018, which claims benefit of German Patent Application No. 20 2017 101 994.2, filed Apr. 4, 2017.

### BACKGROUND OF THE INVENTION

The present invention relates to a baking substrate consisting of a sheet-type material which has, on an upper side, an embossed structuring that is provided with a non-stick coating. EP 2 044 842 B1 discloses a baking substrate which has profilings in the form of curved elevations and depressions, which are embossed onto both sides. The product to be baked can thus rest on the upper side of the profilings and yet air can still flow around the product due to the intermediate spaces between the profilings. Such baking substrates have proven useful, but it is difficult for users to distinguish between the upper side and underside and the baking substrate can easily slip on a support.

To enhance the slip resistance of a baking substrate, it is proposed in EP 2 984 933 A1 to apply a slip-resistant coating made of an elastomer to at least some regions on the underside. The slip-resistant coating reinforces the sheet-type material, which thus becomes somewhat stiffer. The sheet-type material used is a paper or a foil, which forms a smooth surface, and thus no air flow is achieved around the underside of a product to be cooked.

The problem addressed by the present invention is therefore that of providing a baking substrate consisting of a sheet-type material which enables improved handling when baking.

### SUMMARY OF THE INVENTION

The above and other objects are achieved according to one embodiment by a baking substrate comprising: a sheet-type material having an upper side including an embossed structuring that includes a non-stick coating, and an underside that is flat at least in some regions, wherein at least the flat regions have a non-slip coating at least in some areas.

The baking substrate according to the invention consists of a sheet-type material which has, on an upper side, an embossed structuring, for example bumps, cup-shaped elevations, lines, ribs, or other patterns, which, when a product to be baked rests thereon, enables an air flow around the non-bearing regions, the troughs or depressions on the upper side. The underside, which due to the sheet-type design of the baking substrate has an embossed structuring similar to the upper side, is smooth, that is to say flat, at least in some regions, wherein at least the smooth regions are provided with a non-slip coating at least in some areas. As a result, when the baking substrate is set down, the smooth region having the non-slip coating can ensure improved adhesion since flat bearing against an underlying surface is possible. This leads to optimized handling since the baking substrate can be deposited on an underlying surface in a comparatively slip-resistant manner and yet still has the advantages of the embossed structuring on the upper side.

Preferably, the non-slip coating comprises a silicone and/or an elastomer, which has particularly good adhesion properties on a baking tray or work surface.

The non-slip coating on the underside may optionally be provided only on the smooth regions, so that the structured regions, which are provided adjacent to the smooth regions, are uncoated. This makes it possible to save material, since only those regions that also ensure improved adhesion are provided with the non-slip coating. The smooth regions on the underside are also the regions that are lowermost in relation to the baking substrate, and the embossed structuring then extends exclusively upwards. The embossing of the baking substrate is then created only on one side, that is to say in a manner pointing upwards from an underside that is smooth or flat. The terms “upwards” and “downwards” relate to the conventional use of the baking substrate, which has a defined upper side and underside.

The non-slip coating on the underside may be applied in different forms, for example in strips, spots or as a grid. The smooth regions on the underside may each have a surface area of at least 1 mm², preferably at least 4 mm², in order to enable flat bearing against an underlying surface.

If a full-surface coating is applied to the underside, an application amount of 2 to 10 g/m² must be applied, wherein some of the applied coating will not come into contact with a support due to the embossed structuring of the baking substrate. Nevertheless, a full-surface coating of the non-stick coating is possible in order to simplify manufacture.

The sheet-type material is preferably made from a paper, in particular an embossed parchment paper or greaseproof paper. It is also possible to use a nonwoven, a metal foil, in particular an aluminium foil, or multilayer composite materials as the sheet-type material. Preferably, the paper used has a weight per unit area of between 30 to 55 g/m², in particular 35 to 45 g/m², and may optionally be provided with a thin silicone layer of 0.4 g/m² to 0.6 g/m² at least on the upper side, said silicone layer having a non-stick function.

For targeted coating of the baking substrate on the underside, the non-slip coating may be applied by printing, preferably in a discrete pattern. Optionally, the coating on the underside may also contain a magnetic material, for example a magnetized iron powder, in order to improve adhesion to a baking tray.

### BRIEF DESCRIPTION OF THE DRAWINGS

The invention will be explained in greater detail below on the basis of several exemplary embodiments and with reference to the accompanying drawings, in which:

FIG. 1 shows a perspective view of a baking substrate according to the invention during use;

FIGS. 2 to 5 show several views of an underside of different exemplary embodiments of baking substrates, and

FIGS. 6 to 8 show several schematic detail views of different baking substrates when resting on a support.

### DETAILED DESCRIPTION OF THE INVENTION

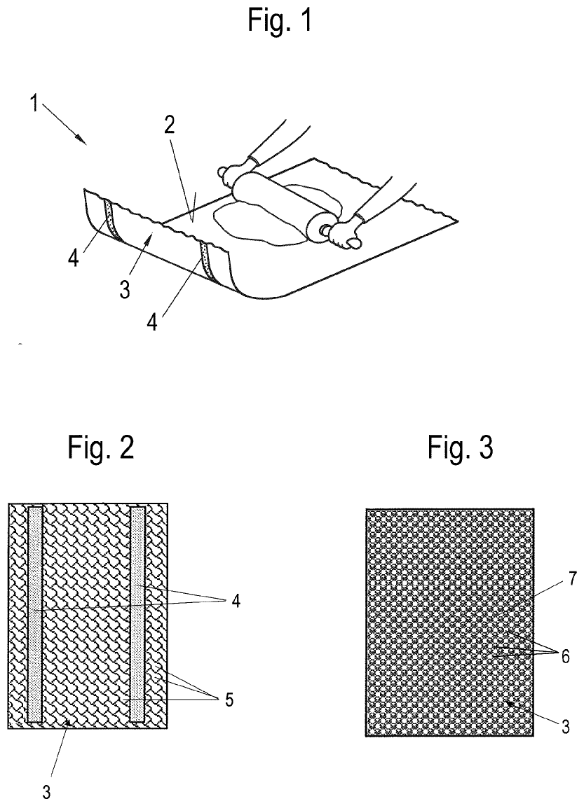

Referring to FIG. 1, there is shown a baking substrate 1 comprising a sheet-type material which can optionally be unwound from a roll or may exist as a ready-cut section on the roll or as a single sheet in folded form. The sheet-type material is preferably made of a paper, in particular a parchment paper, but may also be made of a nonwoven, a metal foil or a composite material. The baking substrate 1 comprises an upper side 2, onto which a product to be cooked can be placed, and an underside 3, which can be placed onto a baking tray or another carrier for a product to be cooked. Two strips 4 comprising a non-slip coating are provided on the underside 3 and bring about improved adhesion of the baking substrate 1 to a support.

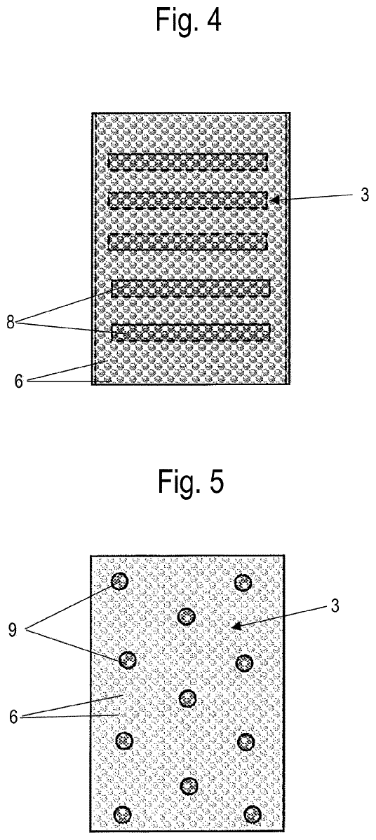

FIG. 2 shows the underside 3 of the baking substrate 1. It is possible to see on the underside, between the two strips 4 extending in the longitudinal direction, honeycomb-shaped embossings 5 which are created by an embossed structuring. The embossing 5 leads to a non-flat surface of the baking substrate 1, which enables improved air flow around the underside of a product to be baked. On the underside, however, the baking substrate 1 can still be deposited on an underlying surface in a slip-resistant manner by way of the flat strips 4.

FIG. 3 shows an underside 3 of a baking substrate, in which no strips 4 are provided on the underside, but instead just a structuring 6 in the form of bumps, cup-shaped elevations or other geometries, wherein flat regions 7 are provided between the structuring 6. The profiling therefore does not extend across the entire surface of the baking substrate 1, but rather only in regions which are spaced apart from one another at least in some areas, and flat or smooth regions are provided between the structurings 6. These flat, smooth regions are coated with a non-slip coating in order to ensure improved adhesion of the baking substrate to a support.

FIG. 4 shows another exemplary embodiment of a baking substrate, in which transverse strips 8 are provided on the underside 3 in addition to the structuring already shown in FIG. 3, said transverse strips being created by a non-slip coating.

In FIG. 5, the baking substrate of FIG. 3 is modified such that spots 9 are additionally provided, said spots being created by a non-slip coating. Other geometries instead of strips or spots can also be used for the non-slip coating, for example a grid structure.

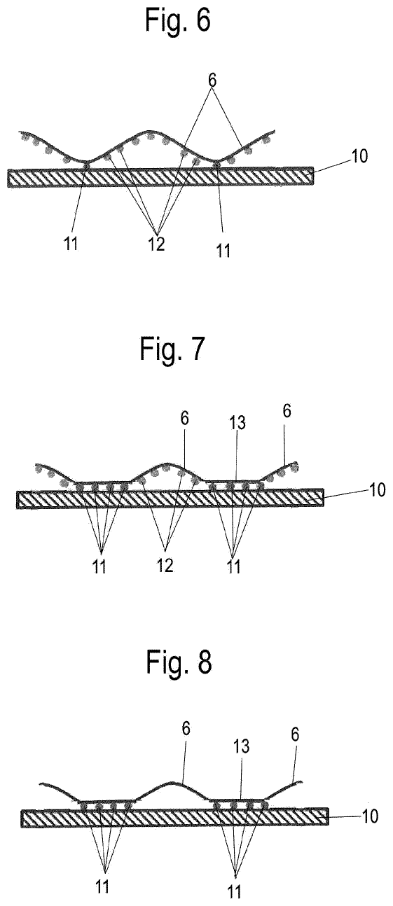

In a baking substrate shown in FIG. 6, which is not according to the invention, a structuring 6 is provided which extends continuously across the entire surface of the baking substrate, for example as shown in EP 2 044 842 B1. The embossing on both sides creates a corrugated structure. If the illustrated corrugated baking substrate is coated on the underside, a non-slip coating 11 is formed at only a few spots, namely those spots that bear against the support 10. The other coating spots 12 are arranged at a distance from the support 10 and thus can make no contribution to improving the adhesion properties.

In a baking substrate according to the invention, as shown in FIG. 7, smooth regions 13 are therefore located between the curved structures 6 and ensure an increased contact area on the support 10. A coating arranged on the underside is designed as a non-slip coating 11 in the flat regions, the surface area of the non-slip coating 11 on the flat regions 13 being at least 1 mm2, preferably more than 4 mm2. The curved structures 6 are arranged between the flat regions 13, and the coating spots 12 are provided at a distance from the support 10.

In another exemplary embodiment of a baking substrate according to the invention, as shown in FIG. 8, only the flat regions are provided with a non-slip coating 11, while the curved structuring 6 on the underside is uncoated. As a result, improved adhesion to the support 10 can be achieved while using a small amount of material, since only the regions that bear against the support 10 are provided with the non-slip coating 11. The non-slip coating 11 comprises a silicone elastomer or another elastomer in order to improve the adhesion properties. If the non-slip coating is applied to the entire surface, as shown in FIG. 7, the non-slip coating is applied in an application amount of 5 to 20 g/m2. If the application takes place only on the smooth regions 13, as shown in FIG. 8, the application amount can be reduced to, for example, 1 to 4 g/m2, in particular 1.5 to 2.5 g/m2, without this having any disadvantageous effect on the adhesion behaviour.

Exemplary embodiment of a baking substrate:

A greaseproof paper which is embossed on some or all of its surface and which has a weight per unit area of 35 to 50 g/m2, preferably 39 to 41 g/m2, is siliconized on the upper side, wherein the coating consists of platinum silicone with a weight per unit area of approximately 0.3 to 1 g/m2, preferably 0.4 to 0.6 g/m2. The underside is coated on some or all of its surface with a plastic material. The plastic material preferably consists of a silicone elastomer and has a soft, elastic and smooth surface. This results in good adhesion to cellulose (paper) and also to other substrates, such as for example metal or plastic. The greaseproof paper thus coated has a temperature resistance of greater than 220° C. The coating amount is selected such that the cellulose fibres on the coated regions are covered with a continuous silicone elastomer film, for which purpose an application amount of 5 to 20 g/m2 is required in the case of paper products. In the case of smooth, non-fibrous (non-absorbent) substrates, such as plastics or aluminium foils, a reduced coating concentration may be sufficient to achieve the effect. Instead of a silicone, it is also possible to use another elastomer having the properties described above.

In a manner differing from the exemplary embodiment above, use may optionally also be made of a coating material containing 20% to 80% of a permanent-magnetic or magnetizable material, which brings about a semi-permanent adhesion of the baking substrate to magnetizable materials, such as iron or steel.

The proportion of the smooth regions 13 on the baking substrate 1 in relation to the total surface area may be, for example, between 5% to 80%, in particular 50% to 70%.

1. A baking substrate comprising: a sheet-type material having an upper side including an embossed structuring that includes a non-stick coating, and an underside that is flat at least in some regions, wherein at least the flat regions have a non-slip coating at least in some areas.

2. The baking substrate according to claim 1, wherein the non-slip coating comprises at least one of a silicone elastomer and another elastomer.

3. The baking substrate according to claim 1, wherein the embossed structuring on the upper side includes bumps that reduce a surface area that bears against a product to be baked.

4. The baking substrate according to claim 1, wherein only the flat regions on the underside include the non-slip coating, and the underside has structured regions that are substantially uncoated.

5. The baking substrate according to claim 1, wherein the non-slip coating on the underside is comprised of strips, spots or a grid.

6. The baking substrate according to claim 1, wherein each flat region has a surface area of at least 1 mm².

7. The baking substrate according to claim 1, wherein an entire surface of the underside includes the non-slick coating in an application amount of 1 to 10 g/m².

8. The baking substrate according to claim 1, wherein the sheet-type material comprises paper.

9. The baking substrate according to claim 8, wherein the paper has a weight per unit area of between 30 to 55 g/m².

10. The baking substrate according to claim 1, wherein the non-slip coating is printed on the underside.

11. The baking substrate according to claim 1, wherein the non-stick coating on the upper side has a weight per unit area of between 0.3 to 1 g/m².

12. The baking substrate according to claim 1, wherein the non-slip coating includes a magnetic material.

13. The baking substrate according to claim 1, wherein the sheet-type material has a temperature resistance of at least 220° C.

14. The baking substrate according to claim 1, wherein each flat region has a surface area of at least 4 mm².

15. The baking substrate according to claim 1, wherein the sheet-type material comprises an embossed greaseproof paper.

16. The baking substrate according to claim 8, wherein the paper has a weight per unit area of between 35 to 45 g/m².

17. The baking substrate according to claim 1, wherein the non-stick coating on the upper side has a weight per unit area of between 0.4 to 0.6 g/m².
